(19) United States
(12) Patent Application Publication
(10) Pub. No.: US 2012/0047546 A1
(43) Pub. Date: Feb. 23, 2012

(54) MEDIA DISTRIBUTION NETWORK, COMPONENTS AND METHODS THEREFOR

(76) Inventor: Michael Milloy, Wanchai (HK)

(21) Appl. No.: 13/259,238

(22) PCT Filed: Mar. 18, 2010
(86) PCT No.: PCT/AU10/00313

§ 371 Date: Sep. 23, 2011

(30) Foreign Application Priority Data
Mar. 25, 2009 (AU) 2009901269

(51) Int. Cl. H04N 21/25

(52) U.S. Cl. 725/115

(57) ABSTRACT

The present invention relates to media distribution network, media reproduction unit, and methods therein. A preferred form of the present invention relates to an overlay network and associated devices and methods for the distribution of audio visual media, for example advertising, informational and entertainment programs. Each media reproduction unit is provided with a unique identifier which can be stored in a stored in a memory such as a ROM.

### FIELD OF THE INVENTION

The present invention relates to media distribution network, components for such networks and methods therein. A preferred form of the present invention relates to a network topology and associated devices and methods for the distribution of audio visual media, for example advertising, informational and entertainment programs.

### BACKGROUND OF THE INVENTION

Systems and methods are known for distributing media content. For example, broadcast networks such as free-to-air, subscription and pay per view television networks are widely used for delivering audio visual programmes to large numbers of display devices.

More recently, the Internet has been used to deliver audio visual programmes to a display device e.g. a user's PC upon request.

Furthermore, proprietary systems for distributing informational and entertainment audio visual content have been widely installed in buildings, such as hotel infrastructure e.g. public places etc. These networks comprise a plurality of dumb terminals configured to play content that is typically streamed from a media server. Whilst it is possible to link numerous sites to a head office via a network, such systems are often cumbersome and require complicated (and usually manual) processes to be put in place to ensure that each screen in the network is showing the correct program at the correct time. Take for example the case of a casino which has a range of different areas, each of which has video screens installed in it that are able to show audio visual content. The casino will have bar areas, gaming areas, casual dining areas and fine dining areas as well as entrance lobbies and foyers. At different times of the day each of these different areas will be required to either show the same content or different content. For example, in a casino environment a show which is playing at the theatre may be promoted on video screens in bars, gaming areas, casual dining areas, foyers and lobbies, but not in fine dining areas. Thus the scheduling for such audio visual content must exclude the fine dining areas. Moreover, in some cases it may be necessary to announce the fact that a particular event has just happened with some urgency, for example the jackpot has been won in the gaming area. When such an event occurs, it may be desirable to advertise that a jackpot has been won, but gaming regulations may only permit such information to be displayed in designated areas of the premises, for example gaming rooms. In such systems, it is difficult to ensure that the correct content is displayed on the correct screens in a manner that enables rapid programming of new audio visual programmes to be displayed on either all or a subset of the screens.

FIG. 1A illustrates a network 100 comprising a plurality of sub-networks 102, 104, 106, 108, 120, 112, 114, 116. The network includes a plurality of wired and wireless communications links e.g. links 118 and 120 respectively. By these communications links a plurality of servers 122 to 130 can communicate with each other and a plurality of video display units e.g. units 132 to 142. As will be appreciated each of the network components may communicate with each other via a range of known physical communications channels using appropriate communications protocols without limit.

In this embodiment, the network 100 can be divided into sub-networks, which each communicate with each other either directly of through a gateway between sub-networks of different types. Each sub-network can be deployed over, for example a particular geographical region. For example, sub-network 102 may be a network within a hotel in each of its sub-networks 106,108 and 110 may relate to different areas within the hotel. For example, area 106 may be a reception area, area 108 may be a casual dining area and area 110 may be a casino area of the hotel. Similarly the sub-network 104 may be divided in a similar fashion, although it may have different sub areas defined within it depending on its own particular physical configuration. For example, the sub-network 104 may be divided into sub-networks are physically tied to floors of the building. If media data is to be transmitted over this network it may have a central management server for controlling distribution of content to the sub-networks.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In a first aspect, the present invention provides a media reproduction unit including: a unique identifier associated with the reproduction unit and used to identify the media reproduction unit; scheduling means adapted to determine an order of reproduction of media data in accordance with scheduling data, said scheduling data being associated with the reproduction system at least partly on the basis of the unique identifier; and a processor for reproducing media data for subsequent display in accordance with the determined an order of reproduction.

The reproduction unit can additionally include one or more display systems for displaying the reproduced media data. For example the display systems can include one or more video screens, video projectors or similar visual display.

The media reproduction unit can be, without limitation, a video billboard, a video display unit in a public space, on a transport system, in a business etc.

Reproducing the media data can include, but is not limited to: retrieving the media data from storage; transmitting a signal representing the media data, or arranging therefore; converting the media data from one form to another, e.g. decompressing or transcoding the media data.

The unique identifier may be stored in a storage medium, or may be the result of the specific configuration of hardware. For example, the storage medium may be a smart card, a hard disk drive, a flash memory, or a read-only memory. When a storage medium is used, it may be provide for initialisation or changing of the unique identifier by the manufacturer. It should be understood that other measures may be employed to prevent access to or changing of the unique identifier by other parties. It may also be that the unique identifier is the result of the specific configuration of hardware. For example, the unique identifier may be derived by the position of a number of dual in-line package (DIP) switches, or be printed or otherwise fabricated into the media reproduction unit.

The reproduction unit additionally includes a data store, configured for storing media data thereon.

The scheduler can include an authentication component configured to cooperate with at least one other system to authenticate the media reproduction unit using at least the unique identifier associated with the reproduction unit.

The media reproduction unit can include a communication component configured to enable the media reproduction unit to communicate over a data network according to a network protocol. The media reproduction unit having a network address which is distinct from its unique identifier.

The media reproduction unit can be configured to be in data communication with a media distribution network.

In a second aspect of the present invention there is provided a media distribution overlay network, including one or more media distribution nodes and media reproduction nodes identifiable by unique identifier associated therewith.

Most preferably the media distribution overlay network has a topology that is different to the topology of an underlying physical network or combination of networks on which the overlay network operates.

In a preferred form, the media reproduction nodes include a media reproduction unit of an embodiment of the first aspect of the present invention.

The media distribution nodes can include one or more of the following: a scheduling server configured to store thereon scheduling data for a plurality of media reproduction nodes; a media storage server storing thereon media data for distribution to at least one media reproduction node; broadcast server for causing distribution of scheduling data across a plurality of media reproduction nodes.

In a third aspect of the present invention, there is provided a method in a media distribution overlay network of updating scheduling data. The method includes the steps of: receiving, at a scheduling data server, a request from a media reproduction node to update scheduling data on the media reproduction node, the request including a unique identifier associated with the reproduction unit; verifying the unique identifier to determine whether the request should be fulfilled; in the event that the request should be fulfilled, determining if new scheduling data should be transmitted to the media reproduction node; and in the event that new scheduling data should be transmitted to the client, enabling transmission of the new scheduling data.

In a preferred embodiment, the request includes data indicative of scheduling data currently known to the media reproduction node. The step of determining if new scheduling data should be transmitted to the media reproduction node can include comparing the data indicative of scheduling data currently known to the media reproduction node to corresponding data relating to the most recent schedule data and in the event that they do not match determining that updated scheduling data should be transmitted to the client.

In some embodiments, the request includes secondary identification data, e.g. the latitude and longitude of the media reproduction node, a date or time stamp of the request or relating to the creation, or updating of the current scheduling data, revision number, hash of the current scheduling data etc. The method can further include a step of verifying that the secondary data corresponds to known secondary data relating to the media distribution node.

In a fourth aspect of the present invention there is provided, a method in a media distribution overlay network of updating media data. The method includes the steps of: receiving, at a media data server, a request from a media reproduction node to update media stored on the media reproduction node, the request including a unique identifier associated with the reproduction unit; verifying the unique identifier to determine whether the request should be fulfilled; and in the event that the request should be fulfilled, enabling transmission of the new media data.

In a fifth aspect of the present invention there is provided a method in a media distribution overlay network of broadcasting media data. The method includes the steps of: identifying media to be broadcast to a plurality of media reproduction units; updating schedule data corresponding to the plurality of media reproduction units on a scheduling server to include at least one schedule item relating to the media to be broadcast.

The method can include providing the updated scheduling data to at least a subset of the media reproduction units, e.g. individually upon receipt of a scheduling data update request from a media reproduction unit, or by pushing updated scheduling data, or a trigger to request updated scheduling data, to the media reproduction units.

The method can include providing media data corresponding to the media to be broadcast to a media content server.

The step of retrieving the new schedule from the scheduling server can be performed in accordance with an embodiment of another aspect of the present invention.

As used herein, except where the context requires otherwise, the term “comprise” and variations of the term, such as “comprising”, “comprises” and “comprised”, are not intended to exclude further additives, components, integers or steps.

### BRIEF DESCRIPTION OF THE DRAWINGS

Preferred forms of the present invention will now be described by way of illustrative example only with reference to the accompanying drawings, in which:

FIG. 1A illustrates a physical network over which a media distribution overlay network according an embodiment of the present invention may be deployed;

FIG. 1B illustrates an the logical connections in an example overlay network which can be deployed over the physical network of FIG. 1A;

FIG. 2 illustrates schematically an embodiment of a media reproduction unit according to an embodiment of the present invention;

FIG. 3 illustrates schematically a server system according to an embodiment of the present invention;

FIG. 4 is a schematic representation of the topology of the media distribution overlay network according to an embodiment of the present invention;

FIG. 5 illustrates steps in an exemplary process for allocating a unique identifier to a media reproduction unit;

FIG. 6 illustrates the steps in an exemplary process for a media reproduction unit requesting a schedule from a server;

FIG. 7 illustrates steps in an exemplary method for a media reproduction unit requesting media data from a server;

FIG. 8 illustrates the steps in an exemplary method used by a broadcast server for causing the broadcast of a schedule update to a plurality of media reproduction units;

FIG. 9 illustrates the steps in an exemplary method of authenticating a media reproduction unit of a media distribution node of the overlay network; and

FIG. 10 illustrates the steps in an exemplary method of viewing and/or updating the schedule for one or more media distribution nodes of the overlay network.

### DETAILED DESCRIPTION OF THE EMBODIMENTS

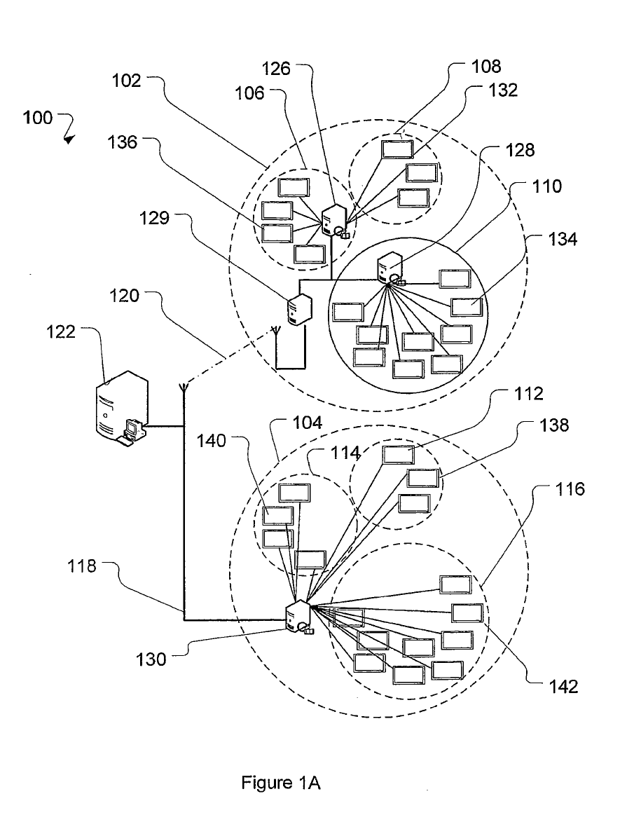

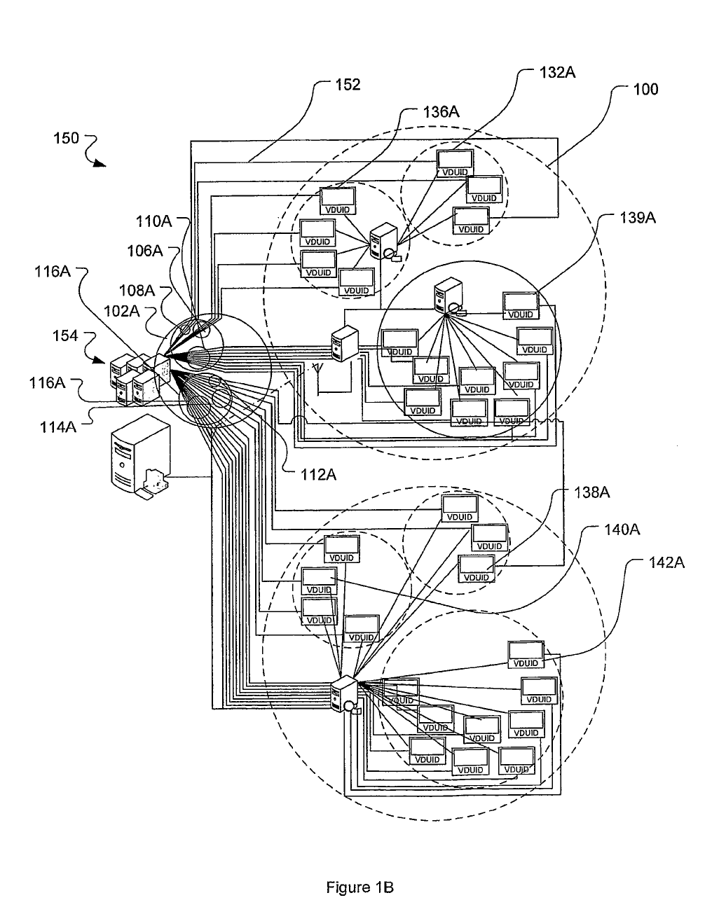

The network of FIG. 1A can be adapted to implement an embodiment of the present invention by providing a media distribution overlay network 150 on top of the physical network 100 described above in relation of FIG. 1A. In order to implement this, video display units need to be modified to be able to operate as media reproduction units according to an embodiment of an aspect of the present invention. To do this, each media reproduction unit is provided with a unique identifier (VDUID) which is permanently associated with it, e.g. by attaching a permanently mounted ROM chip within the unit. The VDUID is a large number or string, which is sufficiently large that the VDUIDs are unique between all media reproduction units of the network. The media reproduction units also needs a processor configured (e.g. by running appropriate client software) to control reproduction of the media in accordance with scheduling data.

The media reproduction unit can obtain a network address and default route for communicating with media distribution servers using any traditional means, for example using BOOTP or DHCP (although the present invention should be considered to apply to networks other than IPv4 networks).

FIG. 1B illustrates the logical connections in an overlay network 150 implemented over the top of the physical network of FIG. 1A. In this figure the logical connections, e.g. connection 152, between the media reproduction units e.g. 132A and the media distribution nodes 154 are prominently illustrated over the physical network of FIG. 1A.

Using its VDUID a media reproduction unit e.g. 132A to 142A can interact with media distribution nodes 154 of the network eg to request the latest schedule. This involves the media reproduction unit 132A sending an encrypted copy of its VDUID and related identification and scheduling data to the server 154 from which the request is made.

The VDUID can also be used by a user or administrator of the system for scheduling content for display on a particular media reproduction device, for example by allowing a hierarchical grouping of the media reproduction units according to their VDUID. Names can be given to groups of the media reproduction units and represents sub-networks within the overlay network. Each named group may contain other named groups. The groups of media reproduction units are illustrated in FIG. 1B by the groupings of logical connections 102A to 116A. In this example the groupings correspond to the physical groupings of FIG. 1A, but in need not (and most likely will not) in most implementations.

Schedules may be organised by a user such that they refer to a particular sub-set e.g. groups, 102A to 116A of media reproduction units by referring to either the name of a sub-group. Each name is associated with at least one VDUID but may correspond to an infinite number of media reproduction unit VDUIDs.

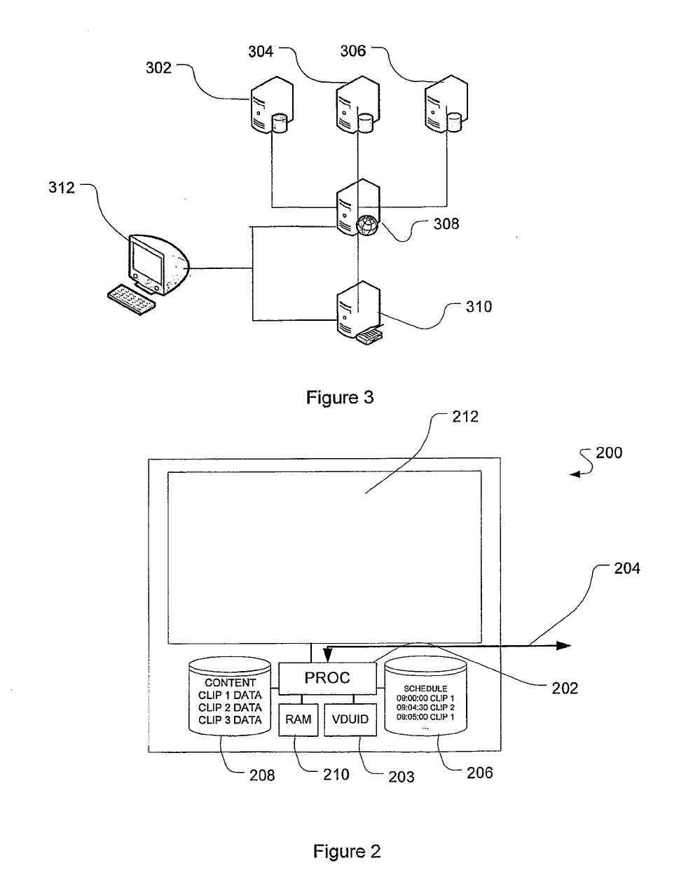

FIG. 2 is a schematic block diagram of a media reproduction unit 200. The media reproduction unit 200 includes a processor 202 (or group of processors) which executes instructions (e.g. in the form of client software) that control the operation of the media reproduction unit to perform the following functions:
communicate via network interface 204 with other nodes of the overlay network (via the underlying physical network using the appropriate protocols);
access scheduling information stored in scheduling database 206;
reproduce content stored in media data storage 208.

The media reproduction unit 200 additionally includes a permanently associated unique identifier (VDUID) 202 stored within non volatile memory e.g. a ROM 203, within the media reproduction unit. The processor also has associated with it memory 210 which stores data used by the processors in executing its tasks. It will be appreciated that the VDUID may be stored in a storage medium, or may be the result of the specific configuration of hardware.

For example, in some embodiments the VDUID will be stored on a storage medium such as a smart card, a hard disk drive, a flash memory, or a read-only memory. The manufacturer may purchase an off-the-shelf storage device, and then initialise the device so that it contains a VDUID selected by the manufacturer. It will be understood that certain precautions may be taken to avoid the VDUID being read or modified by an unauthorised person. For example, the VDUID may be stored in a tamper-resistant device, such as a smartcard.

In some embodiments, the VDUID will be the result of hardware configuration. For example, the VDUID may be derived by the position of a number of dual in-line package (DIP) switches, or be printed or otherwise fabricated into the media reproduction unit. In such embodiments, the VDUID may either be encrypted, or unencrypted; the hardware configuration achieving storage of the data regardless of any encryption.

In this example, the media reproduction unit includes a screen 212 on which the media data e.g. data representing video programmes, advertisements, news, textual displays and the like, can be rendered. The screen 212 can be made of a plurality of individual display screens, and could comprise an LCD screen, plasma screen, cathode ray tube, a colour LED display or any other display capable of rendering text and images thereon. In some embodiments, the media reproduction unit 200 may not include a display but may include a video output to which a terminal or other display monitor is connected. Moreover, the media reproduction unit can include a projector configured to project media onto a remotely located screen or surface.

The media reproduction unit can additionally include audio output means, either in the form of speakers for directly reproducing sound, or an audio output port for outputting audio data to audio reproduction and/or processing devices such as external speakers, an amplifier, PA system or the like. In use, the VDUID stored on the ROM 203 is used by the processor to authenticate data communication with other nodes of the media distribution overlay network.

In a particularly preferred form the media reproduction unit is a stand alone device, incorporating a display, sufficient processing, communications and data storage capability to perform operate in accordance with an embodiment of the present invention. In this manner deployment of a network in accordance with an embodiment of the present invention is relatively straightforward.

The media distribution overlay network of FIG. 1B additionally includes media distribution nodes 154, an example of which are illustrated in FIG. 3. In this example, the media distribution nodes include three media storage servers 302, 304 and 306, a broadcast server 308 and a scheduling server 310. Each of these servers can be connected by the overlay network to the media reproduction nodes of the overlay network. The distribution nodes are in data communication with a management console 312 or interface to control operation of the network. For example, the management console 312 can be used to update schedules as desired, change or add media content on the content servers 302 to 306 or cause broadcasting of media data to all or a subset of the media reproduction units.

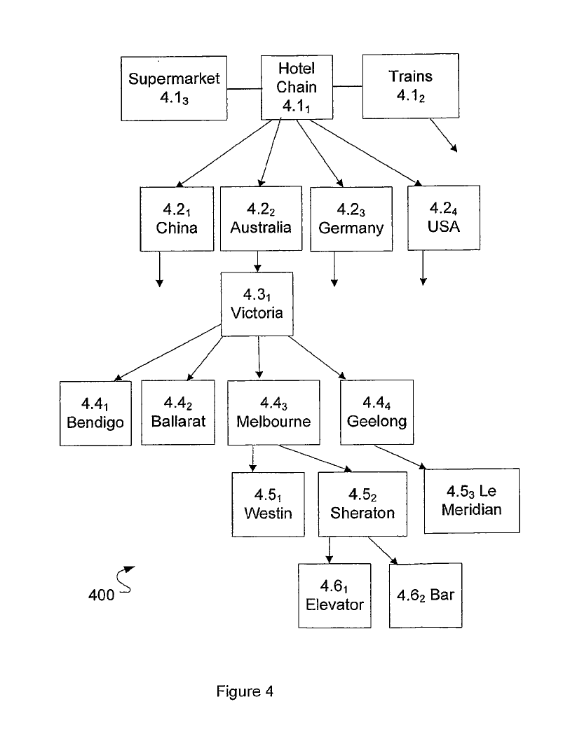

FIG. 4 schematically illustrates the topology of the overlay network to assist in understanding how the overlay network can be used in distributing media data to one or more media reproduction units. FIG. 4 illustrates a hierarchically arranged overlay network 400. At its top level, the network is divided into sub-networks 4.1₁, 4.1₂ and 4.1₃. In a system where the distribution system is run by a central authority for a plurality of businesses, the sub-networks can correspond to different businesses which share the overlay networks. For example, in this case sub-network 4.1₁ relates to a hotel chain (which may for example, correspond to sub-network group 102A in FIG. 1B). Within the top level sub-network 4.1₁ there are further sub-networks 4.2₁ to 4.2₄ (which may for example, correspond to sub-networks 106A, 108A, 110A in FIG. 1B). In this case, at the second level, the sub-networks are grouped according to geographical location, and more specifically countries. Sub-network 4.2₂ relates to Australia. The hierarchical nature of the overlay network 400 continues by narrowing geographical area to sub-network 4.3₁ which is a state based sub-network, down to sub-networks 4.4₁ to 4.4₄ for cities within the state of the previous level in the hierarchy. Within each city sub-networks relating to particular properties are defined eg sub-network 4.5₁, 4.5₂ and 4.5₃ relate to different properties within their respective city. Each of these sub-networks can be further broken into sub-networks for example, sub-network 4.5₂ contains two sub-networks 4.6₁ and 4.6₂. These bottom level sub-networks contain a plurality of media reproduction units located in elevators and bars respectively of the Sheraton Hotel in Melbourne, Victoria, Australia. In use, content can be distributed to media reproduction units by grouping the content and distributing it according to any level within the hierarchy of the overlay network. For example, content can be updated for all properties within the entire hotel chain by changing the media distribution rules and schedules for the hotel chain 4.1₁. Similarly if the system administrator decides that all of the screens within the hotel chain's Melbourne properties need to be updated to reproduce particular media, e.g. Melbourne's weather report, the rescheduling can take place with reference to all screens at the level of sub-network 4.4₃. Similarly, if all media reproduction units in a bar, or all of the bars in one particular property need to be updated the appropriate sub-network eg 4.6₂ can be selected. The hierarchical approach described herein may also be augmented or switched for a functional approach to classification of media reproduction units within the overlay network. For example, all media reproduction units within elevators across the entire overlay network may be updated simultaneously, e.g. to change the format of floor numbers displayed thereon.

The distribution of media and scheduling data through the overlay network 400 will now be described in connection with several examples in FIGS. 4 to 10.

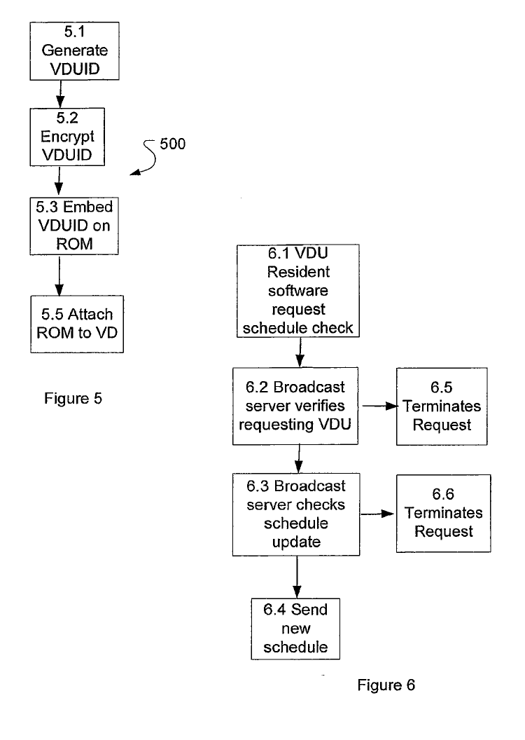

Turning firstly to FIG. 5, as described above in connection with FIG. 2, each media reproduction unit has a VDUID permanently associated with it. FIG. 5 displays the steps in process which can be used to create and store the VDUID on each media reproduction unit. In a first step at 5.1 a VDUID is generated for the media reproduction unit. The VDUID can be created in many ways, e.g. by generating a random string of a particular length, by generating or a assembling or generating the string on the basis of serial numbers or other identifiers associated with one or more components of the media reproduction unit. Next, the VDUID is encrypted in step 5.2 and then, in step 5.3 embedded on a ROM device. The ROM device is attached to the media reproduction unit such that the ROM may be interrogated by the processor of the media reproduction unit to obtain the VDUID and either forward it in an encrypted or unencrypted fashion to the media distribution node of the overlay network for authentication of communications between the media reproduction unit and the media distribution node.

FIG. 6 shows steps in a method of a media reproduction unit checking its stored schedule with a scheduling server of the overlay network. This process can take place at predetermined intervals or on an ad-hoc basis, such as when prompted by a technician.

In a first step 6.1 the processor of the media reproduction unit initiates a request for a schedule check and transmits this across the overlay network to a broadcast server of the network. The broadcast server in step 6.2 verifies that the requesting media reproduction unit is part of the sub-network for which the broadcast server is providing data. This verification is performed using the VDUID of the media reproduction unit which is transmitted in the request in a manner described below.

In the event that verification fails the request is terminated in step 6.5. If the media reproduction unit passes verification with the broadcast server, the broadcast server in step 6.3 checks for relevant schedule updates. In the event that there are no schedule updates nominated for the media reproduction unit making the request, the request is terminated in step 6.6. On the other hand, if a schedule update is due to be sent to the media reproduction unit a new schedule is transmitted in step 6.4.

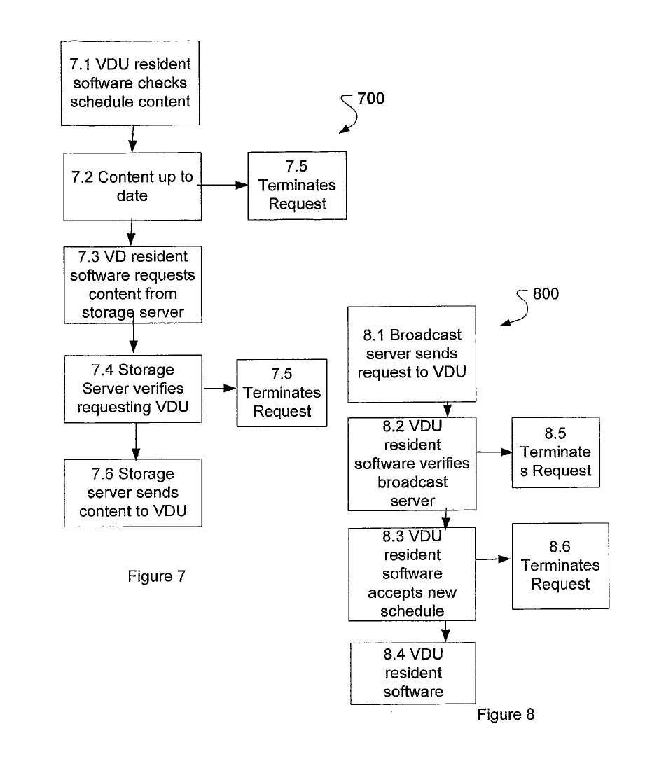

From time to time when the media reproduction unit has had a new schedule supplied to it in the matter described above the media reproduction unit will need to check whether it has the correct media data to reproduce the media data according to its new schedule. The process for doing this is disclosed in FIG. 7. In FIG. 7 the process starts at step 7.1 by the processor of the media reproduction unit interrogating the content database eg 208, and checking whether the content specified by its corresponding schedule is up to date.

If the content is up to date the process terminates at step 7.5. If the content is not up to date the processor sends a request to the media storage server. The storage server authenticates the request by the media reproduction unit in a manner analogous to that described below. If authentication fails the request is terminated at step 7.5. However, on the other hand if authentication succeeds in step 7.6 the storage server transmits media data to the media reproduction unit via the network. Once the schedule and media data have been updated the processor of the media reproduction unit can reproduce its scheduled media as required for display.

From time to time it will be necessary to either adjust the scheduling across all or a subset of the media reproduction units i.e. to broadcast a particular portion of media data. For example, this might occur with news broadcasts, sports scores, emergency broadcasts or the like. In this case, the broadcast server will trigger a broadcast update of all media reproduction unit schedules across the entire network or subset for which the broadcast is to be performed. The process for doing this is shown in FIG. 8. In FIG. 8 in the first step 8.1 the broadcast server sends a broadcast request to a media reproduction unit. In step 8.2 the media reproduction unit performs authentication process with the broadcast server. If authentication fails the request is terminated and no updating is performed. However, in step 8.3 if the authentication is successful the processor of the media reproduction unit updates the stored schedule data with the new schedule data sent by the broadcast server. It should be noted however that the media data itself has not been broadcast across the network merely the scheduling data. Accordingly, in step 8.4 the media reproduction unit needs to implement a method such as that discussed in connection with FIG. 7 to obtain any new media data required to play the new schedule that has been broadcast to it.

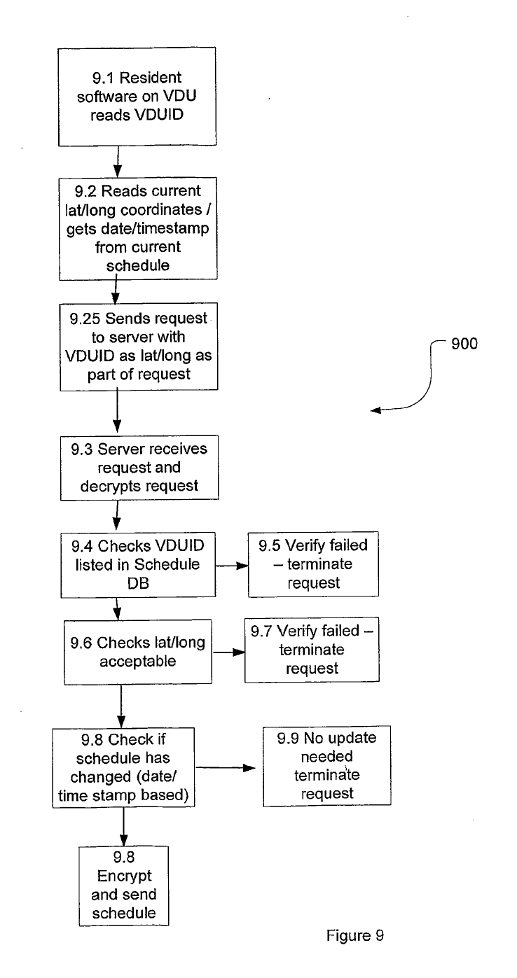

FIG. 9 illustrates an example of an authentication process which may be followed in certain embodiments of the present invention. For example, when a media reproduction unit needs to communicate with any one of the content distribution nodes of the overlay network.

The method 900 begins with the processor of the media reproduction unit reading the VDUID from its associated ROM in step 9.1. Next in Step 9.2, the processor obtains relevant identification data such as date and time stamps associated with its current schedule and any other identification data such as its latitude and longitude coordinates if these are provided either in data form or via an associated positioning device (e.g. a GPS) in step 9.2. These data are combined into a request in step 9.25 and sent to the server. In the next step 9.3, the server receives the request and decrypts it. In step 9.4 the server checks that the received VDUID is valid. In step 9.5 if the VDUID is not valid, the request is terminated. If the VDUID is valid in step 9.6, the other data sent in the request, such as latitude and longitude data is compared to the stored data regarding the media reproduction device. If the additional data does not match the corresponding stored data for the media reproduction unit, the request is terminated in step 9.7. Thus authentication with the server is completed.

If scheduling update is associated with the request, step 9.8 is performed. In this step, the server checks if the schedule associated with the media reproduction unit has changed. This performed on the basis of either a date and time stamp of the schedule which is transmitted in the request, a version number either transmitted in the request or stored in a database within the server. In the event that no update is needed in step 9.9, the request is terminated. In the event that an update is required, the schedule is encrypted and transmitted across the network to the video reproduction device in step 9.8.

In some implementations of the present invention, a system of video terminals, perhaps which are simply monitors, may need to be retrofitted to be connected to operate in an embodiment of the present invention. To do this the terminals need to be provided with a VDUID and sufficient data processing, networking and data storage capability to run client software adapted to implement the invention as described above. This could be achieved by providing a media reproduction unit, without a display that reproduces media and outputs a video stream to the monitor e.g. a VGA output or, in an extreme case a rasterised output for driving the monitor, which can then be applied to the monitor for creating the display. Such a device can look similar to a “set top box” digital video decoder.

By using a media distribution overlay network rather than the topology of the underlying networks, which may be rather complicated and operate on a number of different protocols, updating and scheduling media to be displayed is relatively straight forward in a preferred embodiment of the present invention.

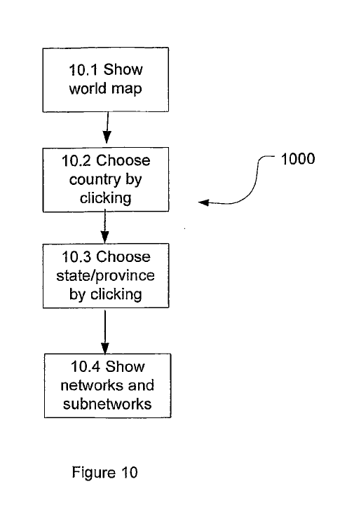

As described above, this may be performed using the management terminal 312 which is connected to the overlay network. This management terminal may be provided with a an interface and allow a user thereof to navigate to particular sub-networks within the overlay network and initiate either broadcast or schedule updates for those groups. For example, FIG. 10 illustrates a process by which a user of the management terminal 312 can select which one of the sub-networks or individual media reproduction units is to be updated. In this method 1000, a media distribution application or a web interface is opened on the management terminal 312. For example, the management terminal may provide the user a hierarchical graphical user interface. Initially, the user interface may show a world map in step 10.1. The user can then navigate through the interface to their desired sub-network by for example by clicking a country displayed within the map in step 10.2. Next particular province may be chosen in step 10.3. After this in step 10.4, all sub-networks within the province can be displayed to the user who can then select which of the sub-networks needs to be updated with the particular schedule change or broadcast. As will be appreciated, the user may also need to update the contents stored on the contents server as this will be required once the schedule update is sent to the selected sub-network.

In preferred embodiments, the amount of data transmitted over the network is kept relatively low by only transmitting scheduling data and/or media data to a media reproduction unit in the event that it has changed or it is not possessed by the media reproduction unit. This is in contrast to an approach that will re-send scheduling data upon request, even if it has not been updated since the last transmission to the media reproduction unit. Moreover preferred embodiments of the system will advantageously only transmit those portions of schedule data to a media reproduction unit that have been changed i.e. only schedule data relating to updated timeslots will be sent, further limiting data transmission across the network and bandwidth requirements.

Similarly an administrator of an area with a number of media reproduction units, e.g. a hotel manager, could be enabled to update the schedule for screens within their administration area. The administrator can be provided with, e.g. a web interface, similar to the management terminal interface. However, it is preferable that any changes to schedules or content are initially only provisional and are not released to the scheduling, content or broadcast servers, for use on the network until they are vetted and authorised by a manager of the entire system (or appropriate part of it).

In addition to simplifying distribution of content and minimising the potential for incorrect reproduction of media, a preferred embodiment present invention limits the possibility that centralised failure can cause a large scale problem in the network by requiring distribution of content for local storage and access by each media reproduction unit. For example in a streaming system of the prior art, if the media streaming server fails then all screens taking the feed from it will fail. In contrast if any one component of illustrative embodiment fails, only a portion of the system will be affected, e.g. only one media reproduction unit will fail if there is a problem with it or its data; or one portion of the days playback will be out of date or incorrect if the scheduling, broadcast or content servers fail, because preferably only updates are sent to the media reproduction units with each update.

It will be understood that the invention disclosed and defined in this specification extends to all alternative combinations of two or more of the individual features mentioned or evident from the text or drawings. All of these different combinations constitute various alternative aspects of the invention.

1. A media reproduction unit comprising:
a unique identifier associated with the reproduction unit and used to identify the media reproduction unit;
scheduling means adapted to determine an order of reproduction of media data in accordance with scheduling data, said scheduling data being associated with the reproduction system at least partly on the basis of the unique identifier; and
a processor for reproducing media data for subsequent display in accordance with the determined an order of reproduction.

2. The media reproduction unit of claim 1, wherein the media reproduction unit further includes one or more display systems for displaying the reproduced media data.

3. (canceled)

4. The media reproduction unit of claim 1 wherein the media reproduction unit forms at least part of:
a video billboard,
a video display unit in a public space,
a video display unit on a transport system,
a video display unit in a business.

5. The media reproduction unit of claim 1, wherein the unique identifier is stored on a storage device selected from the following list:
a smart card,
a hard disk drive,
a flash memory,
a read-only memory.

6. The media reproduction unit of claim 1, wherein the media reproduction unit further includes a data store, configured for storing media data thereon.

7. The media reproduction unit of claim 1, wherein the scheduling means includes an authentication component configured to cooperate with at least one other system to authenticate the media reproduction unit using at least the unique identifier associated with the reproduction unit.

8. The media reproduction unit of claim 1, wherein the media reproduction unit further includes a communication component configured to enable the media reproduction unit to communicate over a data network according to a network protocol.

9. The media reproduction unit of claim 8, wherein the media reproduction unit has a network address which is distinct from its unique identifier.

10-13. (canceled)

14. The media distribution overlay network of claim 11, wherein the media distribution nodes include one or more of the following:
a scheduling server configured to store thereon scheduling data for a plurality of media reproduction nodes;
a media storage server storing thereon media data for distribution to at least one media reproduction node; and
broadcast server for causing distribution of scheduling data across a plurality of media reproduction nodes.

15. A method in a media distribution overlay network of updating scheduling data, including the steps of:
receiving, at a scheduling data server, a request from a media reproduction node to update scheduling data on the media reproduction node, the request including a unique identifier associated with the reproduction unit;
verifying the unique identifier to determine whether the request should be fulfilled;
in the event that the request should be fulfilled, determining if new scheduling data should be transmitted to the media reproduction node; and
in the event that new scheduling data should be transmitted to the client, enabling transmission of the new scheduling data.

16. The method according to claim 15, wherein the request includes data indicative of scheduling data currently known to the media reproduction node.

17. The method according to claim 16 wherein the step of determining if new scheduling data should be transmitted to the media reproduction node includes:
comparing the data indicative of scheduling data currently known to the media reproduction node to corresponding data relating to the most recent schedule data, and;
in the event that they do not match, determining that updated scheduling data should be transmitted to the client.

18. The method according to claim 15, wherein the request includes secondary identification data.

19. The method according to claim 18, wherein the secondary identification data is at least one of:
the latitude and longitude of the media reproduction node,
a date or time stamp of the request or relating to the creation, or updating of the current scheduling data,
a revision number of the current scheduling data, and
a hash of the current scheduling data.

20. The method of claim 18 wherein the method further includes a step of verifying that the secondary data corresponds to known secondary data relating to the media distribution node.

21. (canceled)

22. A method in a media distribution overlay network of broadcasting media data, including the steps of:
identifying media to be broadcast to a plurality of media reproduction units
updating schedule data corresponding to the plurality of media reproduction units on a scheduling server to include at least one schedule item relating to the media to be broadcast.

23. The method of claim 22, wherein the method further includes providing the updated scheduling data to at least a subset of the media reproduction units.

24. The method of claim 23 wherein the step of providing updated scheduling data is performed:
individually, upon receipt of a scheduling data update request from a media reproduction unit, or;
by pushing updated scheduling data, or;
by a trigger to request updated scheduling data, to the media reproduction units.

25. The method of to claim 22, wherein the method includes providing media data corresponding to the media to be broadcast to a media content server.

26. The method of claim 23, wherein the step of providing updated scheduling data is performed by a trigger to request updated scheduling data to the media reproduction units, and the media reproduction unit retrieves the new schedule from the scheduling server using a method including the steps of:
receiving, at a scheduling data server, a request from a media reproduction node to update scheduling data on the media reproduction node, the request including a unique identifier associated with the reproduction unit;
verifying the unique identifier to determine whether the request should be fulfilled;
in the event that the request should be fulfilled, determining if new scheduling data should be transmitted to the media reproduction node; and
in the event that new scheduling data should be transmitted to the client, enabling transmission of the new scheduling data.
